(19) United States
(12) Patent Application Publication
(10) Pub. No.: US 2024/0329902 A1
(43) Pub. Date: Oct. 3, 2024

(54) INFORMATION PROCESSING APPARATUS THAT USES CLOUD PRINT SERVICE, CONTROL METHOD FOR INFORMATION PROCESSING APPARATUS, AND STORAGE MEDIUM

(71) Applicant: CANON KABUSHIKI KAISHA, Tokyo (JP)

(72) Inventor: TSUBASA HIRANO, Kanagawa (JP)

(21) Appl. No.: 18/737,343

(22) Filed: Jun. 7, 2024

Related U.S. Application Data
(63) Continuation of application No. PCT/JP2022/037965, filed on Oct. 12, 2022.

(30) Foreign Application Priority Data
Dec. 9, 2021 (JP) 2021-200256

(51) Int. Cl. G06F 3/12

(52) U.S. Cl. CPC G06F 3/1265; G06F 3/1222; G06F 3/1238; G06F 3/1292

(57) ABSTRACT

It is possible to suppress a data transfer cost in printing using a cloud print service. A client terminal 102 transmits a print job for printing data to an image forming apparatus 101 via a cloud print service 107. In a case that the image forming apparatus 101 has a capability to process a reference print job that has designated a storage location of the data in a URI format, the client terminal 102 transmits the reference print job to the cloud print service 107.

### CROSS-REFERENCE TO RELATED APPLICATIONS

This application is a Continuation of International Patent Application No. PCT/JP2022/037965, filed on Oct. 12, 2022, which claims the benefit of Japanese Patent Application No. 2021-200256, filed on Dec. 9, 2021, both of which are hereby incorporated by reference herein in their entirety.

### BACKGROUND OF THE INVENTION

### Field of the Invention

The present invention relates to an information processing apparatus that uses a cloud print service, a control method for the information processing apparatus, and a storage medium.

### Background Art

A printing system, in which a client terminal that is an information processing apparatus transmits a print job to an image forming apparatus via a cloud print service, has been known (for example, see Patent Literature 1). In such a printing system, the client terminal obtains document data from a storage location designated by a user, generates a print job based on the obtained document data, and transmits the print job to the image forming apparatus via the cloud print service.

### CITATION LIST

### Patent Literature

Patent Literature 1: Japanese Laid-Open Patent Publication (kokai) No. 2012-133489

In cloud print services, there is a case where a capacity limit for print jobs is set for the purpose of load reduction or the like. When, to a cloud print service that a capacity limit for print jobs has been set as described above, a print job including document data with a file size exceeding the capacity limit is transmitted, the cloud print service refuses to receive the print job including the document data with the file size exceeding the capacity limit. That is, a problem arises in that the print job is not transmitted to the image forming apparatus and printing of the print job is not executed.

In addition, as a charging system for the cloud service, charging is generally performed according to the amount of data transferred. That is, there is also a problem in that as the amount of data transferred increases, the cost of maintaining the cloud print service increases.

### SUMMARY OF THE INVENTION

The present invention provides an information processing apparatus that suppresses a data transfer cost in printing using a cloud print service, a control method for the information processing apparatus, and a storage medium.

In order to achieve the above-described object, an information processing apparatus according to one aspect of the present invention is an information processing apparatus that transmits a print job for printing data to an image forming apparatus via a cloud print service, comprising at least one processor, and a memory coupled to the processor storing instructions that, when executed by the processor, cause the processor to function as a transmitting unit that transmits the print job to the cloud print service. In a case that the image forming apparatus has a capability to process a reference print job that has designated a storage location of the data in a predetermined format, in the transmission, the transmitting unit transmits the reference print job to the cloud print service instead of the print job.

Further features of the present invention will become apparent from the following description of exemplary embodiments with reference to the attached drawings.

### BRIEF DESCRIPTION OF THE DRAWINGS

FIG. 1 is a configuration diagram that shows an example of a printing system.

FIG. 2 is a block diagram that shows a hardware configuration of a client terminal shown in FIG. 1.

FIG. 3 is a block diagram that shows a hardware configuration of an image forming apparatus shown in FIG. 1.

FIG. 4 is a sequence diagram that shows the procedure of a printer registration processing executed by the printing system shown in FIG. 1.

FIG. 5 is a diagram for explaining setting values of the IPP.

FIG. 6 is a sequence diagram that shows the procedure of a conventional cloud print processing.

FIG. 7 is an example of a print job transmission packet from a conventional client terminal to a cloud print service.

FIG. 8 is a sequence diagram that shows the procedure of a first cloud print processing executed by the printing system shown in FIG. 1.

FIG. 9 is an example of a print job transmission packet from the client terminal shown in FIG. 1 to the cloud print service.

FIG. 10 is a sequence diagram that shows the procedure of the first cloud print processing in the case of being determined in a step S811 of FIG. 8 that the image forming apparatus does not have a capability to process a reference print job.

FIG. 11 is a flowchart that shows the procedure of a first print control processing executed by the client terminal shown in FIG. 1.

FIG. 12 is a sequence diagram that shows the procedure of a second cloud print processing executed by the printing system shown in FIG. 1 (a second embodiment).

FIG. 13 is a sequence diagram that shows the procedure of the second cloud print processing in the case of being determined in a step S1210 of FIG. 12 that the image forming apparatus does not have the capability to process a reference print job.

FIG. 14 is a flowchart that shows the procedure of a second print control processing executed by an application of the client terminal shown in FIG. 1.

FIG. 15 is a configuration diagram that shows an example of a printing system according to a third embodiment.

FIG. 16 is a sequence diagram that shows the procedure of a third cloud print processing executed by the printing system shown in FIG. 15.

FIG. 17 is a diagram that shows an example of a setting screen displayed on an output unit of a client terminal shown in FIG. 15.

### DESCRIPTION OF THE EMBODIMENTS

Hereinafter, an embodiment of the present invention will be described in detail with reference to the drawings. Here, before describing a configuration of a printing system in the present embodiment, characteristics of the printing system in the present embodiment will be described. In the printing system in the present embodiment, first, an administrator registers an image forming apparatus in a tenant of a cloud print service. A tenant is one service system deployed on a cloud. Next, the administrator performs settings regarding which users belonging to the tenant are permitted to use the image forming apparatus. A user who has been permitted to use the image forming apparatus submits a print job including document data and print settings to the cloud print service from a client terminal. The cloud print service stores the received print job in a storage. The image forming apparatus obtains the print job stored in the cloud print service and executes a print processing of the obtained print job. It should be noted that the obtaining method of the print job may be pull printing or push printing with respect to the cloud print service.

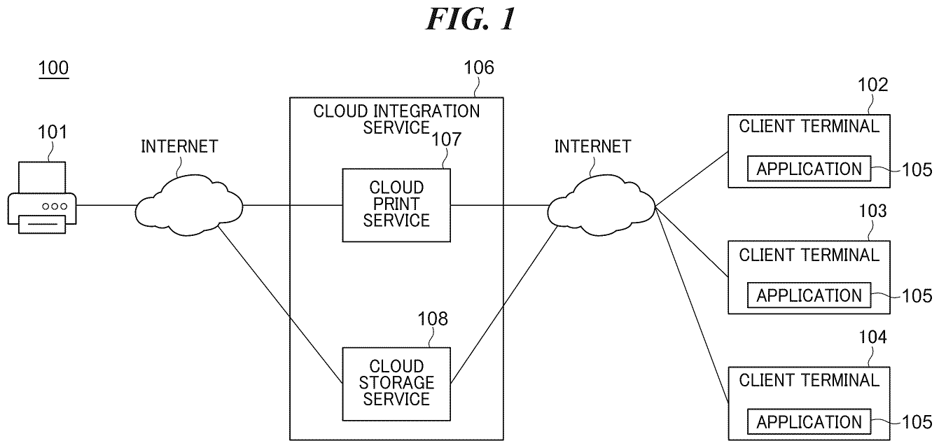

FIG. 1 is a configuration diagram that shows an example of a printing system 100 according to the present embodiment. The printing system 100 includes an image forming apparatus 101, a cloud integration service 106, and one or more client terminals. It should be noted that, in the present embodiment, as an example, a configuration in which the printing system 100 includes three client terminals 102 to 104 will be described. The image forming apparatus 101, the cloud integration service 106, and the client terminals 102 to 104 are each communicably connected to each other via the Internet.

The image forming apparatus 101 is an image forming apparatus registered in a tenant of a cloud print service 107 of the cloud integration service 106. The image forming apparatus 101 obtains a print job from the cloud print service 107 and executes a print processing of the obtained print job.

The client terminals 102 to 104 submit print jobs to the cloud print service 107 of the cloud integration service 106. Each of the client terminals 102 to 104 includes an application 105 for accessing the cloud print service 107. The application 105 is, for example, an Internet browser, a Microsoft Office's application, or Google LLC's Google Drive application. It should be noted that, in the present embodiment, although a configuration will be described in which each of the client terminals 102 to 104 includes the application 105 having the same functions and configuration, the present invention is not limited to this configuration. For example, the client terminals 102 to 104 may include different applications, respectively, as long as they are capable of accessing the cloud print service 107. The user is able to use the application 105 to access the cloud print service 107, and store and edit document data and issue a print instruction of the document data.

The cloud integration service 106 provides a plurality of services such as the cloud print service 107, a cloud storage service 108, and a cloud communication service (not shown). The cloud integration service 106 is, for example, Google LLC's G Suite or Microsoft 365. When the user uses various kinds of services included in the cloud integration service 106, the user is able to access the cloud print service 107 by using the same authentication information. The authentication information is, for example, a user name and a password.

Based on an instruction issued by the user, the cloud print service 107 stores a print job submitted from the client terminal 102 or the like and transmits the print job to the image forming apparatus 101. The cloud storage service 108 is an online storage service and provides a service that manages document data and the like online. The cloud storage service 108 is, for example, Google LLC's Google Drive or Microsoft's OneDrive.

Next, hardware configurations of the client terminals 102 to 104 and the cloud print service 107 will be described. It should be noted that, in the present embodiment, the client terminals 102 to 104 and the cloud print service 107 have similar hardware configurations, and the hardware configuration of the client terminal 102 will be described below as an example.

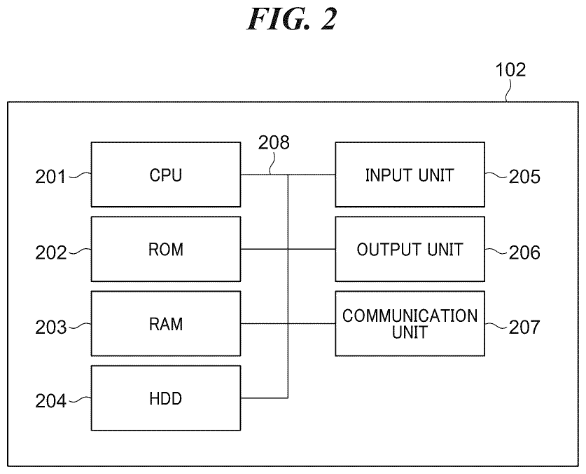

FIG. 2 is a block diagram that shows the hardware configuration of the client terminal 102 shown in FIG. 1. As shown in FIG. 2, the client terminal 102 includes a central processing unit (a CPU) 201, a read only memory (a ROM) 202, a random access memory (a RAM) 203, a hard disk drive (an HDD) 204, an input unit 205, an output unit 206, and a communication unit 207. The CPU 201, the ROM 202, the RAM 203, the HDD 204, the input unit 205, the output unit 206, and the communication unit 207 are connected to each other via a bus 208.

The CPU 201 directly or indirectly controls each device connected via the bus 208, and executes a program for implementing the present invention. The ROM 202 stores a basic input/output system (a BIOS) and the like. The RAM 203 is used as a working area for the CPU 201, and is also used as a primary storage area for loading software modules for implementing the present invention. The HDD 204 stores an operating system (an OS), which is basic software, and various kinds of software modules. It should be noted that, in the present embodiment, the client terminal 102 may have a configuration including a storage device such as a solid state drive (an SSD) that has functions equivalent to the HDD instead of the HDD. The input unit 205 is a keyboard, a pointing device, or the like. The output unit 206 is, for example, a display that displays various kinds of information. The communication unit 207 is an interface for connecting to a network.

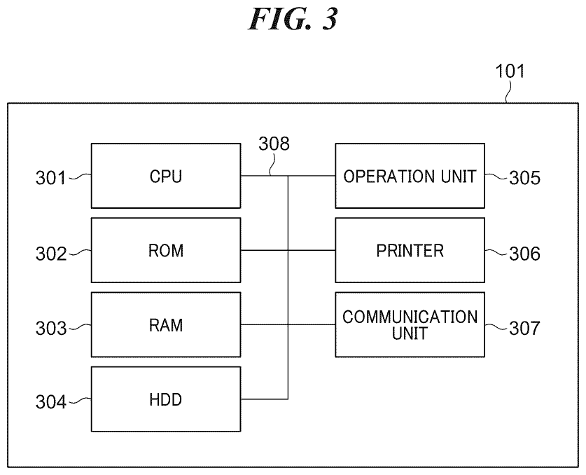

FIG. 3 is a block diagram that shows a hardware configuration of the image forming apparatus 101 shown in FIG. 1. As shown in FIG. 3, the image forming apparatus 101 includes a CPU 301, a ROM 302, a RAM 303, an HDD 304, an operation unit 305, a printer 306, and a communication unit 307. The CPU 301, the ROM 302, the RAM 303, the HDD 304, the operation unit 305, the printer 306, and the communication unit 307 are connected to each other via a bus 308.

The CPU 301 directly or indirectly controls each device connected via the bus 308, and executes a program for implementing the present invention. The ROM 302 stores a BIOS and the like. The RAM 303 is used as a working area for the CPU 301, and is also used as a primary storage area for loading software modules for implementing the present invention. The HDD 304 stores an OS, which is basic software, and various kinds of software modules. It should be noted that, in the present embodiment, the image forming apparatus 101 may have a configuration including a solid state drive (an SSD) or the like that has functions equivalent to the HDD instead of the HDD. The operation unit 305 is a touch-operable display. The printer 306 is a printer engine that executes a print processing of a print job received from the outside via the communication unit 307. The communication unit 307 is a network interface for connecting to the Internet or an office LAN.

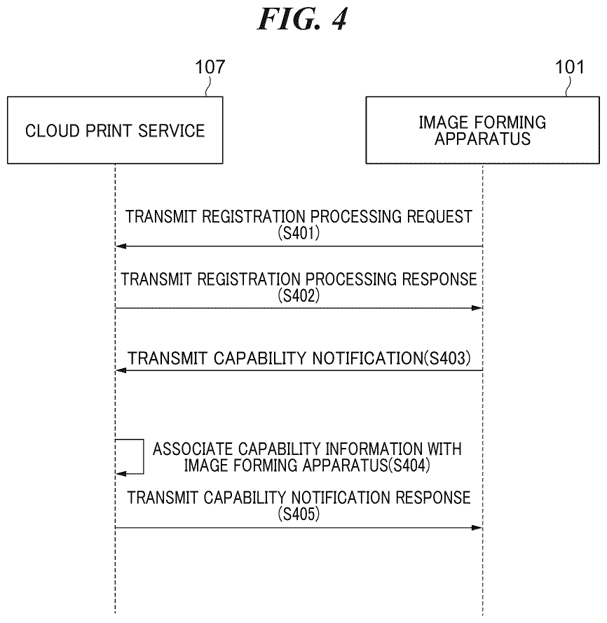

FIG. 4 is a sequence diagram that shows the procedure of a printer registration processing executed by the printing system 100 shown in FIG. 1. The printer registration processing is a processing of registering the image forming apparatus 101 in the cloud print service 107. The printer registration processing is executed by the cloud print service 107 and the image forming apparatus 101. The printer registration processing is executed when the image forming apparatus 101 accepts a registration instruction issued by the administrator. This registration instruction is issued by, for example, an operation in which the administrator selects the cloud print service 107 from the operation unit 305 of the image forming apparatus 101 and selects a registration button (not shown).

As shown in FIG. 4, first, in a step S401, the image forming apparatus 101 that has accepted the registration instruction issued by the administrator transmits a registration processing request, which registers the image forming apparatus 101 in the cloud print service 107, to the cloud print service 107. It should be noted that the protocol for the registration processing is based on the protocol defined by the cloud print service 107, and uses, for example, the Register-Output-Device operation or the like defined by PWG5100.22.

In a step S402, the cloud print service 107 confirms the contents of the received registration processing request, and transmits a registration processing response, which is a response to the registration processing request based on the confirmed result, to the image forming apparatus 101. For example, in the case that there is no problem in the contents of the received registration processing request, the cloud print service 107 performs a predetermined processing that registers the image forming apparatus 101, and transmits a registration processing response, which indicates that the registration has been successful, to the image forming apparatus 101. On the other hand, in the case that there is a problem in the contents of the received registration processing request, the cloud print service 107 does not perform the predetermined processing that registers the image forming apparatus 101, and transmits a registration processing response, which indicates that the registration has failed, to the image forming apparatus 101. In FIG. 4, a description will be given assuming that the registration processing response, which indicates that the registration has been successful, is transmitted to the image forming apparatus 101.

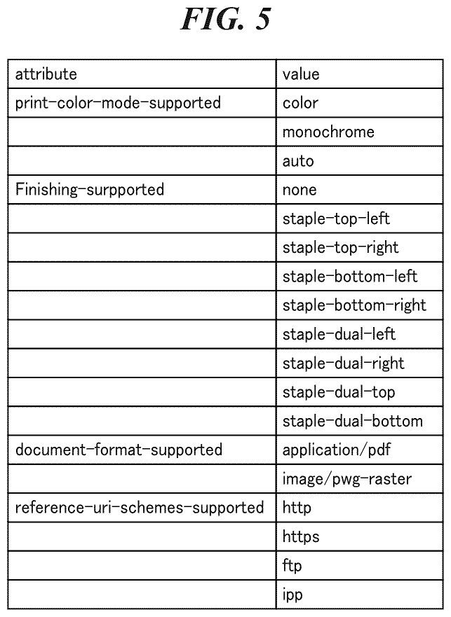

In a step S403, the image forming apparatus 101 that has received the registration processing response, which indicates that the registration has been successful, transmits a capability notification including capability information of the image forming apparatus 101 itself to the cloud print service 107. The capability notification corresponds to, for example, the Update-Output-Device-Attributes operation or the like defined by PWG5100.18. In the present embodiment, the capability notification is transmitted based on, for example, setting values of the Internet Printing Protocol (IPP) that are shown in FIG. 5.

For example, the setting values for the attribute “Print-color-mode-supported” defined by the IPP are “Auto”, “Color”, and “Monochrome”. When “Auto” is selected, a color or monochrome printed matter will be outputted based on the settings of the image forming apparatus 101. When “Color” is selected, a color printed matter will be outputted. When “Monochrome” is selected, a monochrome printed matter will be outputted.

The setting values for the attribute “Finishing-supported” are numerical values, and numerical values corresponding to finishing information supported by the image forming apparatus 101 are set. For example, in the case that “20” associated with “Staple-top-left” has been set, a printed matter stapled at “one place on the top left” will be outputted. In the case that “22” associated with “Staple-top-right” has been set, a printed matter stapled at “one place on the top right” will be outputted.

The setting values for the attribute “document-format-supported” include “application/pdf” and “image/pwg-raster”. These indicate data formats of print jobs that the image forming apparatus 101 is capable of accepting during printing. The setting values for the attribute “reference-uri-schemes-supported” include “http”, “https”, “ftp”, and “ipp”. These indicate which format supports location designation by using a uniform resource identifier (a URI) as a designating method of document data of the print job that the image forming apparatus 101 is capable of accepting during printing. In the step S403, the image forming apparatus 101 transmits a capability notification, which includes information indicating the setting values supported by the image forming apparatus 101 from among the plurality of setting values described above as the capability information, to the cloud print service 107.

In a step S404, the cloud print service 107, which has received the capability notification from the image forming apparatus 101, confirms the contents of the received capability notification, and performs a processing of associating the capability information with the already-registered image forming apparatus 101. In a step S405, the cloud print service 107, which has completed the processing of associating the capability information with the already-registered image forming apparatus 101, transmits a capability notification response, which indicates that the processing of associating the capability information with the already-registered image forming apparatus 101 has been completed, to the image forming apparatus 101. After that, the printer registration processing ends.

Next, a conventional cloud print processing that uses the cloud print service 107 will be described. The conventional cloud print processing is a processing, in which the image forming apparatus 101 registered in the cloud print service 107 performs a print processing of document data stored in the cloud storage service 108 in accordance with a print instruction transmitted from a conventional client terminal 102′, which has the same configuration as the client terminals 102 to 104, to the cloud print service 107. It should be noted that hereinafter, “′” is added to reference signs of the components of the client terminal 102, respectively, and then is shown as reference signs of the components of the client terminal 102′.

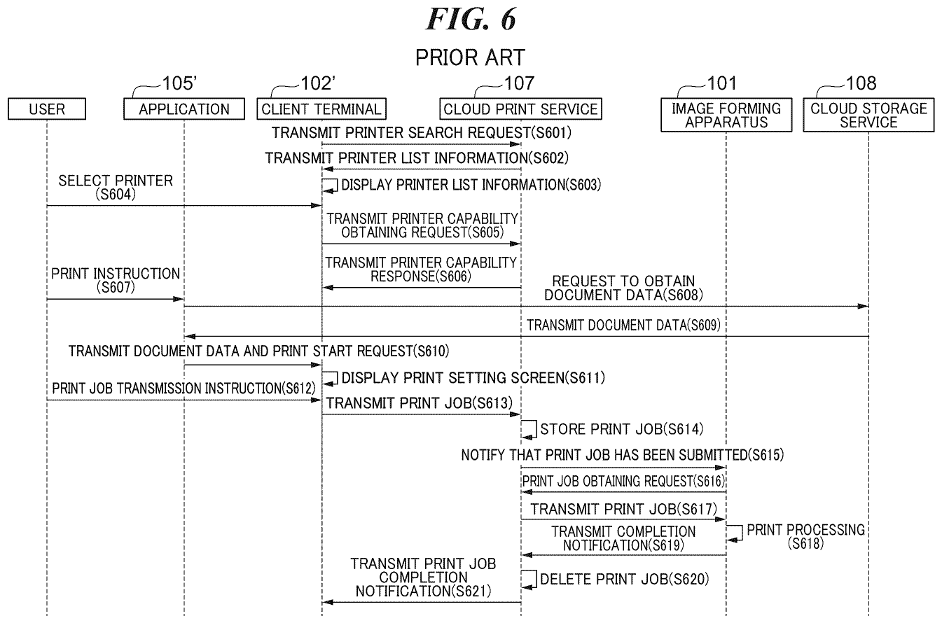

FIG. 6 is a sequence diagram that shows the procedure of the conventional cloud print processing. In the description of FIG. 6, it is assumed that the printer registration processing of FIG. 4 described above has been executed and the image forming apparatus 101 has already been registered in the cloud print service 107. In addition, in the description of FIG. 6, it is assumed that an application 105′ of the client terminal 102′ has logged in to the cloud print service 107 and the cloud storage service 108. When the application 105′ logs in to these, the application 105′ is able to access a resource designated by a URI and to edit or download document data or the like stored in the resource. Furthermore, the application 105′ is able to upload this document data and store it in the cloud print service 107. Moreover, the application 105′ is able to obtain the capability information of the printer from the cloud print service 107 and to issue a print instruction with respect to the image forming apparatus 101, which has been registered in the cloud print service 107, via the cloud print service 107. The conventional cloud print processing is executed when the user inputs a printer search instruction into an input unit 205′ of the client terminal 102′.

As shown in FIG. 6, in a step S601, the client terminal 102′ that has accepted the printer search instruction from the user transmits a printer search request to the cloud print service 107. The printer search may be performed by a method of designating and searching all printers that have been registered in the cloud print service 107, or may be performed by a method of searching by using filter conditions such as the name or location of a specific printer.

In a step S602, the cloud print service 107, which has received the printer search request, transmits printer list information, which indicates printers corresponding to the printer search request from among the plurality of registered printers, to the client terminal 102′.

In a step S603, the client terminal 102′ that has received the printer list information displays the printer list information on an output unit 206′. Next, in a step S604, the user selects one printer, for example, the image forming apparatus 101, from the displayed printer list information. In a step S605, upon detecting that the image forming apparatus 101 has been selected, the client terminal 102′ transmits a printer capability obtaining request for obtaining the capability information of the image forming apparatus 101 to the cloud print service 107. The printer capability obtaining request corresponds to, for example, the IPP's Get-Printer-Attributes operation or the like.

In a step S606, the cloud print service 107 transmits a printer capability response including the capability information of the image forming apparatus 101 to the client terminal 102′ in accordance with the received printer capability obtaining request. As a result, based on the capability information of the image forming apparatus 101 included in the received printer capability response, the client terminal 102′ becomes able to display the print settings and to generate a print job that matches the capabilities of the image forming apparatus 101.

Next, in a step S607, the user opens the document data stored in the cloud storage service 108 by using the application 105′ and issues a print instruction of the document data stored in the cloud storage service 108. In a step S608, the application 105′ that has detected the print instruction from the user transmits a request to obtain document data designated by the user to the cloud storage service 108. In a step S609, the cloud storage service 108, which has received the request to obtain the document data designated by the user, transmits the requested document data to the application 105′.

In a step S610, the application 105′ transmits, to a CPU 201′ of the client terminal 102′, the document data obtained from the cloud storage service 108 and a print start request of the document data obtained from the cloud storage service 108. In this way, the CPU 201′ is notified that the print instruction of the document data obtained from the cloud storage service 108 has been issued. Next, in a step S611, the client terminal 102′ displays, on the output unit 206′, a print setting screen for performing print settings for the obtained document data.

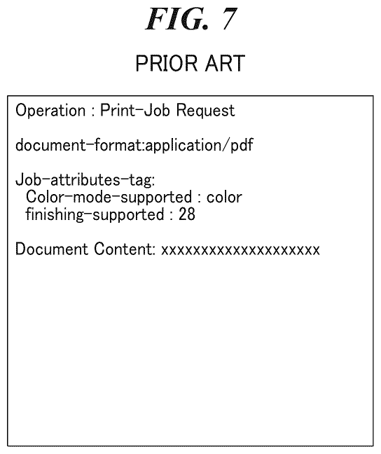

Next, in a step S612, from the print setting screen, the user selects the cloud print service 107 as a print destination to execute printing, and issues a print job transmission instruction of the document data. In a step S613, the client terminal 102′ that has accepted the print job transmission instruction transmits a print job, which includes the obtained document data and the print settings set on the print setting screen, to the cloud print service 107. The print job corresponds to, for example, the IPP's Print-Job operation or the like. FIG. 7 is an example of a print job transmission packet from the conventional client terminal 102′ to the cloud print service 107. In FIG. 7, “Color” and “binding in two places on the left side” are set as the print settings, and PDF is set as the document format of the print job. It should be noted that the substance of the document data has been recorded in Document Content.

In a step S614, the cloud print service 107 stores the received print job in a storage of the cloud print service 107. Next, in a step S615, the cloud print service 107 notifies the image forming apparatus 101 that the print job has been submitted. The notification in the step S615 corresponds to, for example, the IPP's Get-Notifications operation or the like. It should be noted that, in the present embodiment, it is assumed that the cloud print service 107 transmits a PUSH notification to the image forming apparatus 101 in the step S615, but the notification in the step S615 is not limited to the PUSH notification. For example, in the step S615, the image forming apparatus 101 may transmit, to the cloud print service 107, a PULL notification to inquire about the presence or absence of an event.

In a step S616, the image forming apparatus 101 that has received the above-described notification makes a print job obtaining request to the cloud print service 107. The print job obtaining request corresponds to, for example, the IPP's Fetch-Job operation or the like. In a step S617, the cloud print service 107 that has received the print job obtaining request obtains the requested print job from the storage of the cloud print service 107 itself, and transmits the obtained print job to the image forming apparatus 101.

In a step S618, the image forming apparatus 101 executes a print processing of the received print job. In a step S619, when the print processing of the received print job is completed, the image forming apparatus 101 transmits a completion notification, which indicates that the print processing has been completed, to the cloud print service 107.

In a step S620, the cloud print service 107 that has received the completion notification deletes the print job stored in the storage of the cloud print service 107 itself in the step S614. Next, in a step S621, the cloud print service 107 transmits a print job completion notification to the client terminal 102′, and ends this processing.

Here, in the cloud print service 107, there is a case where a capacity limit for print jobs is set for the purpose of load reduction or the like. In the case that, to the cloud print service 107 that a capacity limit for print jobs has been set as described above, a print job including document data with a file size exceeding the capacity limit has been transmitted, the cloud print service 107 refuses to receive the print job including the document data with the file size exceeding the capacity limit. That is, a problem arises in that the print job is not transmitted to the image forming apparatus 101 and printing of the print job is not executed.

In order to solve this problem, in the present embodiment, in the case that the image forming apparatus 101 has a capability to process a reference print job that has designated a storage location of the document data in a URI format, the reference print job is transmitted to the cloud print service 107.

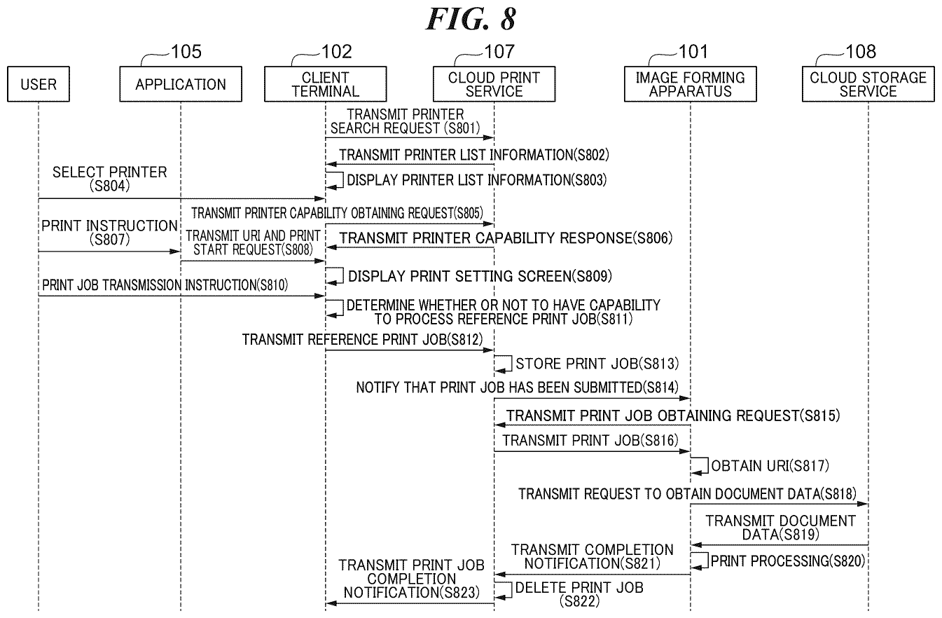

FIG. 8 is a sequence diagram that shows the procedure of a first cloud print processing executed by the printing system 100 shown in FIG. 1. It should be noted that, in the present embodiment as well, similar to the description of FIG. 6, it is assumed that the printer registration processing of FIG. 4 described above has been executed and the image forming apparatus 101 has already been registered in the cloud print service 107. In addition, in the description of FIG. 8, it is assumed that the application 105 of the client terminal 102 has logged in to the cloud print service 107 and the cloud storage service 108. The first cloud print processing is executed when the user inputs a printer search instruction into the input unit 205 of the client terminal 102.

As shown in FIG. 8, first, processes of steps S801 to S806, which are the same processes as the steps S601 to S606, are performed. Next, in a step S807, the user opens the document data stored in the cloud storage service 108 by using the application 105 and issues a print instruction of the document data stored in the cloud storage service 108. In a step S808, the application 105 that has detected the print instruction from the user transmits, to the CPU 201 of the client terminal 102, a URI indicating a storage location of document data designated by the user and a print start request of the document data designated by the user. It should be noted that, in the case that the document data that is a target of the print instruction is local data stored in a local storage of the client terminal 102, it is assumed that the application 105 transmits, to the client terminal 102, rendering data necessary for printing based on the document data, and the print start request. In the present embodiment, as an example of the URI indicating the storage location of the document data designated by the user, it is assumed that a URI “https://example.com/my.cloudstorage/personal/username/Documents/Printdocum ent1.pdf” whose data format is https has been transmitted to the CPU 201 of the client terminal 102. Next, in a step S809, the client terminal 102 displays, on the output unit 206, a print setting screen for performing print settings for the above-described document data.

Next, in a step S810, from the print setting screen, the user selects the cloud print service 107 as a print destination, and issues a print job transmission instruction of the document data. In a step S811, based on capability information included in a printer capability response transmitted from the cloud print service 107 in the step S806, the client terminal 102 that has received the print job transmission instruction determines whether or not the image forming apparatus 101 has a capability to process a reference print job. For example, in the case that “https” indicating the data format of the URI transmitted from the application 105 in the step S808 is included in the above-described capability information, the client terminal 102 determines that the image forming apparatus 101 has the capability to process the reference print job. On the other hand, in the case that “https” indicating the data format of the URI transmitted from the application 105 in the step S808 is not included in the above-described capability information, the client terminal 102 determines that the image forming apparatus 101 does not have the capability to process the reference print job.

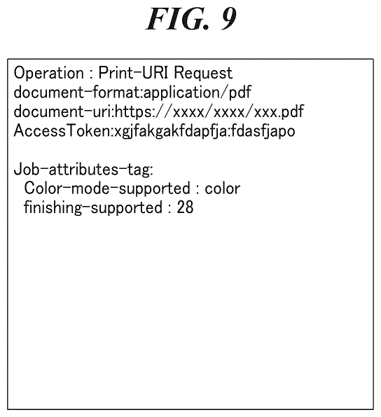

In the case of being determined in the step S811 that the image forming apparatus 101 has the capability to process the reference print job, in a step S812, the client terminal 102 transmits the reference print job to the cloud print service 107. The reference print job is a print job that has designated the storage location of the document data designated by the user in the URI format, and corresponds to, for example, the IPP's Print-URI operation. Furthermore, the reference print job transmitted in the step S812 also includes access information that allows the image forming apparatus 101 to obtain the document data from the cloud print service 107, for example, an access token. The access token is assigned when the client terminal 102 generates the reference print job. FIG. 9 is an example of a print job transmission packet from the client terminal 102 shown in FIG. 1 to the cloud print service 107. In FIG. 9, “Color” and “binding in two places on the left side” are set as the print settings, and PDF is set as the document format of the print job. In addition, the storage location of the document data is set in the https format, and the access token is also set.

Next, steps S813 to S816, which are the same processes as the steps S614 to S617, are performed. Next, in a step S817, the image forming apparatus 101 obtains the URI indicating the storage location of the document data from the received print job. Next, in a step S818, the image forming apparatus 101 transmits, to the cloud storage service 108, a request to obtain document data including the obtained URI, and the access token included in the received print job.

In a step S819, the cloud storage service 108 transmits, to the image forming apparatus 101, the document data corresponding to the received obtaining request. In a step S820, the image forming apparatus 101 executes a print processing based on the received document data and the print job transmitted from the cloud print service 107 in the step S816. When the print processing is completed, steps S821 to S823, which are the same processes as the steps S619 to S621, are performed, and this processing ends.

In this manner, in the present embodiment, the image forming apparatus 101 obtains the document data based on the URI included in the print job and performs printing of the obtained document data without downloading the document data stored in the cloud print service 107 to the client terminal 102.

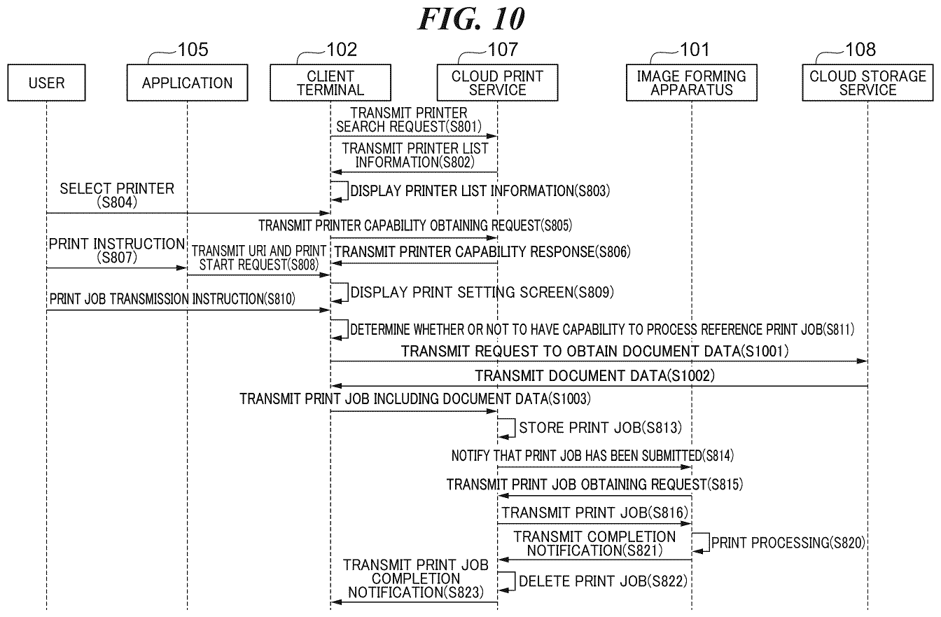

Next, the first cloud print processing in the case of being determined in the step S811 of FIG. 8 that the image forming apparatus 101 does not have the capability to process the reference print job will be described by using a sequence diagram illustrated in FIG. 10. In the case of being determined in the step S811 that the image forming apparatus 101 does not have the capability to process the reference print job, in a step S1001 of FIG. 10, similar to the step S608 described above, the client terminal 102 transmits a request to obtain document data to the cloud storage service 108. In a step S1002, the cloud storage service 108 that has received this obtaining request transmits the requested document data to the client terminal 102.

Next, in a step S1003, the client terminal 102 transmits a print job including the obtained document data to the cloud print service 107. Next, the processes of the steps S813 to S816 and S820 to S822 described above are performed, and this processing ends. The search processing, the generation processing of the print job including the document data, and the transmission processing that have been described with reference to FIGS. 8 and 10 are realized by a print framework built into the operating system (the OS) of the client terminal 102. In the case that the client terminal 102 generates the print job including the document data, it may be configured to perform the conversion of the document data by using a printer driver that constitutes the print framework. In this case, the printer driver converts the document data into data such as PDF, and generates a print job that includes the converted document data.

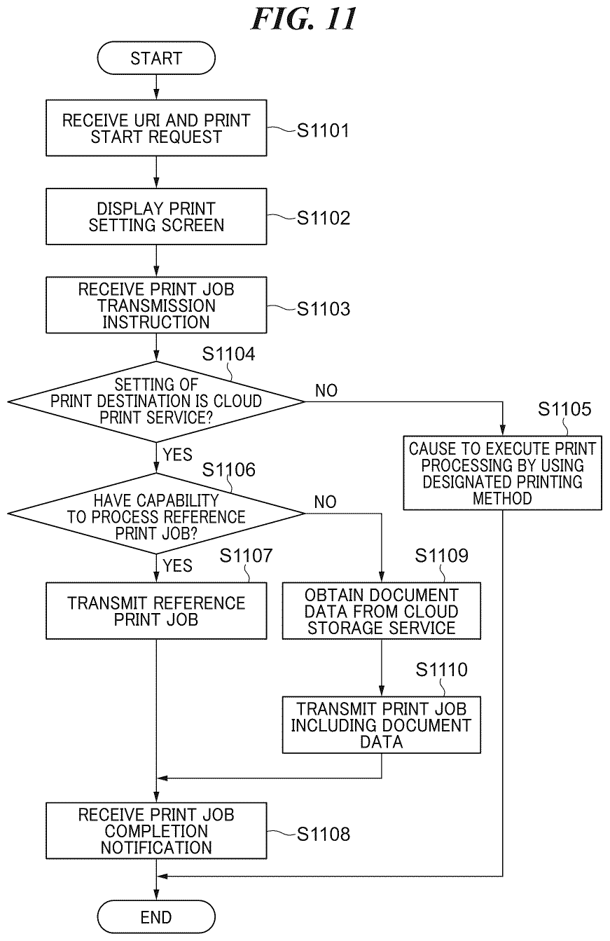

FIG. 11 is a flowchart that shows the procedure of a first print control processing executed by the client terminal shown 102 in FIG. 1. The first print control processing is realized by the CPU 201 of the client terminal 102 executing programs stored in the ROM 202 and the HDD 204. The first print control processing is executed when, in the step S808 described above, the application 105 has transmitted, to the client terminal 102, the URI indicating the storage location of the document data designated by the user and the print start request of the document data designated by the user.

As shown in FIG. 11, first, the CPU 201 receives the URI and the print start request from the application 105 (a step S1101). Next, the CPU 201 displays a print setting screen on the output unit 206 (a step S1102) (for example, see the step S809). On this print setting screen, the user is able to perform the print settings such as the number of copies to print, color, monochrome, etc. In addition, the user is able to select the cloud print service or a printer connected to a local network as the print destination. The user is able to issue a print job transmission instruction by using the selected settings.

When the CPU 201 accepts the print job transmission instruction from the user (a step S1103), the CPU 201 determines whether or not the setting of the print destination on the print setting screen is the cloud print service 107 (a step S1104).

In the case of being determined in the step S1104 that the setting of the print destination on the print setting screen is not the cloud print service 107, the CPU 201 causes the print destination to execute the print processing by using a designated printing method (a step S1105). A case will be described in which, for example, the printer connected to the local network has been designated by the user as the print destination on the print setting screen. The CPU 201 obtains document data from the cloud storage service 108. The CPU 201 transmits a print job, which includes the obtained document data and the print settings set on the print setting screen, to the printer designated by the user, and causes the printer designated by the user to execute a print processing of the above-described print job. After that, this processing ends.

In the case of being determined in the step S1104 that the setting of the print destination on the print setting screen is the cloud print service 107, the CPU 201 determines whether or not the image forming apparatus 101 has the capability to process the reference print job (a step S1106) (for example, see the step S811). In the step S1106, as described above, the determination is made based on the capability information included in the printer capability response transmitted from the cloud print service 107 in the step S806.

In the case of being determined in the step S1106 that the image forming apparatus 101 has the capability to process the reference print job, the CPU 201 transmits the reference print job to the cloud print service 107 (a step S1007) (for example, see the step S812). Based on this print job, the processes of the steps S813 to S822 described above are performed. Next, the CPU 201 receives a print job completion notification from the cloud print service 107 (a step S1108) (for example, see the step S823), and ends this processing.

In the case of being determined in the step S1106 that the image forming apparatus 101 does not have the capability to process the reference print job, the CPU 201 obtains document data from the cloud storage service 108 (a step S1109) (for example, see the steps S1001 and S1002). Next, the CPU 201 generates a print job including the obtained document data, and transmits the generated print job to the cloud print service 107 (a step S1110) (for example, see the step S1003). It should be noted that, in the case that the CPU 201 has received the rendering data necessary for printing based on the document data, and the print start request, the CPU 201 skips the obtaining processing of the document data, generates a print job including print data based on the rendering data received from the application 105, and transmits the generated print job to the cloud print service 107. Based on this print job, the processes of the steps S813 to S816 and S820 to S822 described above are performed. After that, the processing proceeds to the step S1108.

According to the embodiment described above, in the case that the image forming apparatus 101 has the capability to process the reference print job that has designated the storage location of the document data in the URI format, the reference print job is transmitted to the cloud print service 107. In other words, in the case that the image forming apparatus 101 has the capability to process the reference print job, a print job including document data with the file size exceeding the capacity limit of the cloud print service 107 is never transmitted to the cloud print service 107. In addition, the image forming apparatus 101 is able to obtain document data to be printed from a storage location designated in a reference print job. As a result, it is possible to avoid a situation where printing cannot be executed due to the capacity limit of the cloud print service 107.

In the embodiment described above, the document data designated by the user is obtained from the cloud storage service 108 that stores a plurality of pieces of document data. As a result, in the configuration in which the document data is obtained from the cloud storage service 108, it is possible to avoid the situation where printing cannot be executed due to the capacity limit of the cloud print service 107.

In the embodiment described above, the cloud storage service 108 and the cloud print service 107 are accessed by using the same authentication information. That is, the cloud storage service 108 and the cloud print service 107 are accessed by using the authentication information corresponding to the logged-in user. As a result, in the configuration which communicates with the cloud integration service 106 including the cloud storage service 108 and the cloud print service 107 that can be accessed by using the same authentication information, it is possible to avoid the situation where printing cannot be executed due to the capacity limit of the cloud print service 107.

It should be noted that, in the present embodiment, the case where the access token is assigned when the client terminal 102 generates the reference print job has been described as an example. Instead of this, it is also possible to perform the process of assigning the access token on the cloud print service 107. Specifically, the cloud print service 107 requests the cloud storage service 108 to issue an access token required to access the data specified by the URI included in the reference print job. The cloud storage service 108 issues an access token with the same expiration date as the print job's preservation period (for example, three days) and transmits it to the cloud print service 107. The cloud print service 107 adds the received access token to the reference print job and transmits it to the image forming apparatus 101.

Although the present invention has been described above by using the embodiment described above, the present invention is not limited to the embodiment described above. For example, the present invention may have a configuration in which the application 105 of the client terminal 102 directly transmits a print job to the cloud print service 107.

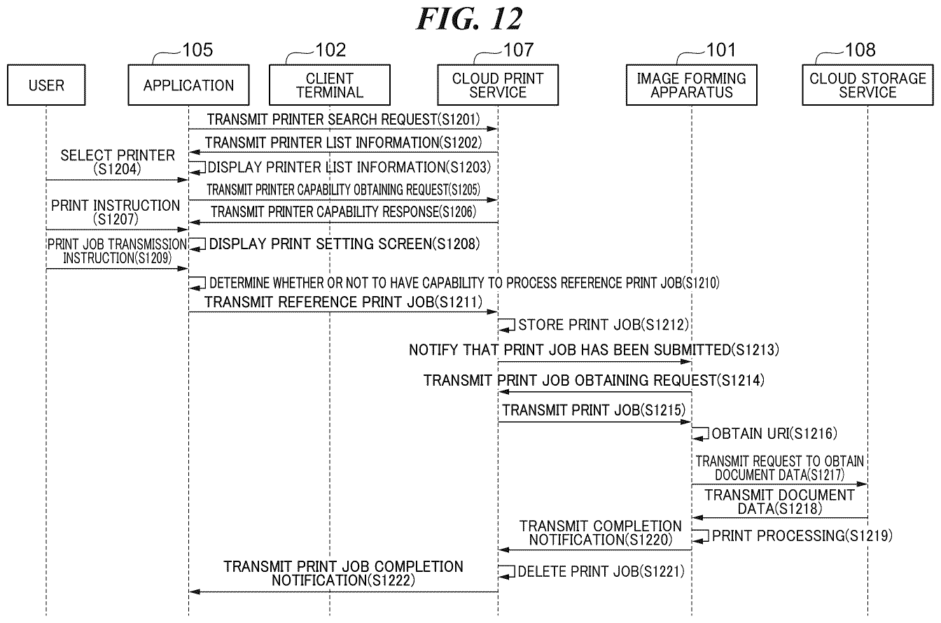

A second embodiment will be described. FIG. 12 is a sequence diagram that shows the procedure of a second cloud print processing executed by the printing system 100 shown in FIG. 1. The second cloud print processing is similar to the first cloud print processing described above, and only the differences from the first cloud print processing will be described below. In the second cloud print processing as well, similar to the first cloud print processing, it is assumed that the printer registration processing of FIG. 4 described above has been executed and the image forming apparatus 101 has already been registered in the cloud print service 107. In addition, in the second cloud print processing as well, similar to the first cloud print processing, it is assumed that the application 105 of the client terminal 102 has logged in to the cloud print service 107 and the cloud storage service 108. The second cloud print processing is executed when the user inputs a printer search instruction on the application 105.

As shown in FIG. 12, in a step S1201, similar to the step S801, the application 105 that has accepted the printer search instruction from the user transmits a printer search request to the cloud print service 107. In a step S1202, the cloud print service 107, which has received the printer search request, transmits printer list information, which indicates printers corresponding to the printer search request from among the plurality of registered printers, to the application 105.

In a step S1203, the application 105 that has received the printer list information causes the output unit 206 to display the printer list information. Next, in a step S1204, the user selects one printer, for example, the image forming apparatus 101, from the displayed printer list information. In a step S1205, similar to the step S805, upon detecting that the image forming apparatus 101 has been selected, the application 105 transmits a printer capability obtaining request for obtaining the capability information of the image forming apparatus 101 to the cloud print service 107. Next, in a step S1206, the cloud print service 107 transmits a printer capability response including the capability information of the image forming apparatus 101 to the application 105 in accordance with the received printer capability obtaining request.

Next, in a step S1207, the user opens the document data stored in the cloud storage service 108 by using the application 105 and issues a print instruction of the document data stored in the cloud storage service 108. In a step S1208, the application 105 that has detected the print instruction causes the output unit 206 to display a print setting screen. Next, in a step S1209, from the print setting screen, the user selects the cloud print service 107 as a print destination, and issues a print job transmission instruction of the document data. Next, in a step S1210, similar to the step S811, based on capability information included in a printer capability response transmitted from the cloud print service 107 in the step S1206, the application 105 determines whether or not the image forming apparatus 101 has a capability to process a reference print job.

In the case of being determined in the step S1210 that the image forming apparatus 101 has the capability to process the reference print job, in a step S1211, the application 105 transmits the reference print job to the cloud print service 107. Next, steps S1212 to S1222, which are the same processes as the steps S813 to S823 described above, are performed.

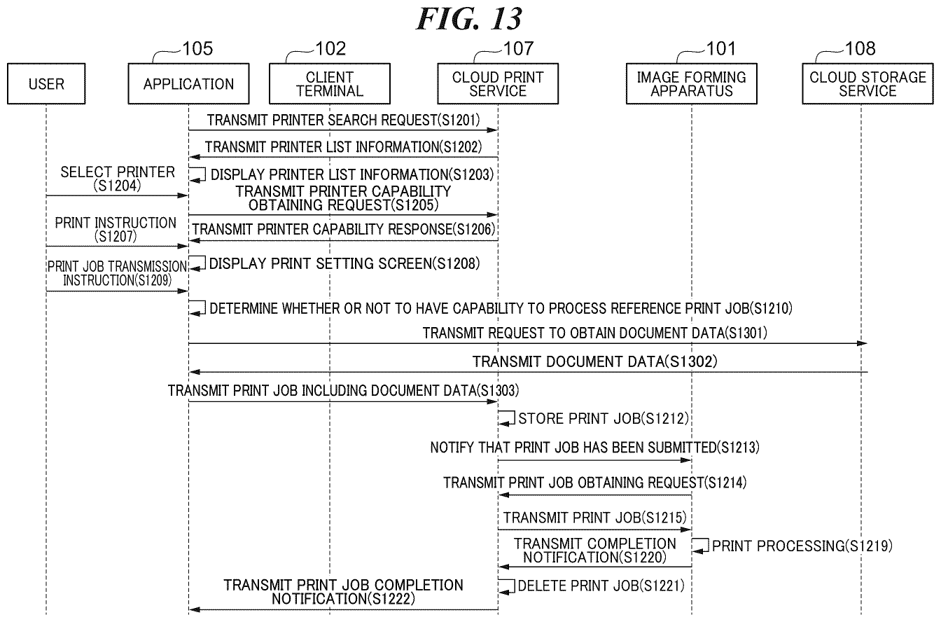

In the case of being determined in the step S1210 that the image forming apparatus 101 does not have the capability to process the reference print job, in a step S1301 of FIG. 13, the application 105 transmits a request to obtain document data to the cloud storage service 108. In a step S1302, the cloud storage service 108 that has received this obtaining request transmits the requested document data to the application 105. Next, in a step S1303, the application 105 transmits a print job including the obtained document data to the cloud print service 107. Next, the processes of the steps S1212 to S1215 and S1219 to S1222 described above are performed, and this processing ends.

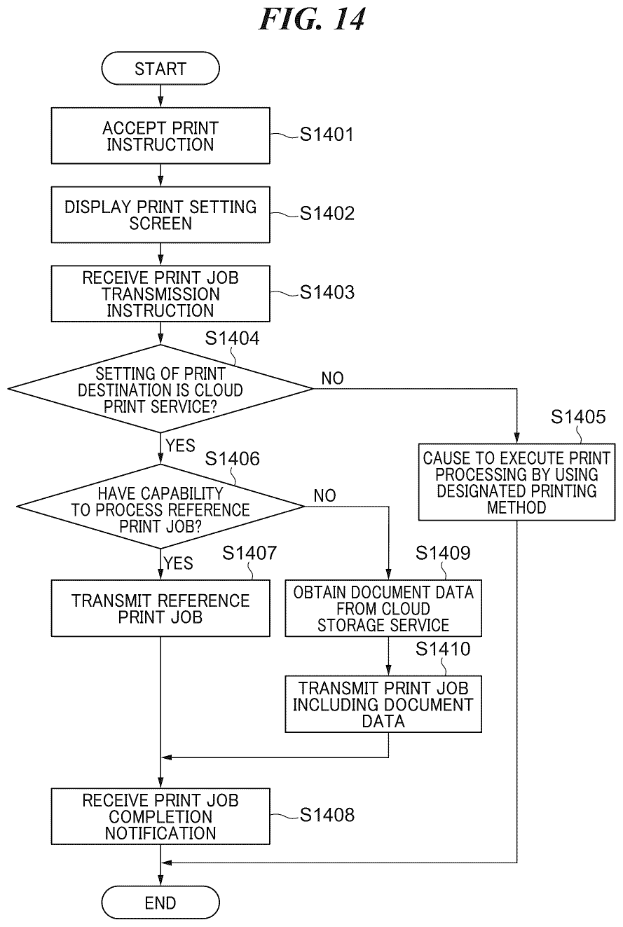

FIG. 14 is a flowchart that shows the procedure of a second print control processing executed by the application 105 of the client terminal 102 shown in FIG. 1. The second print control processing is similar to the first print control processing described above, and differs from the first print control processing in that the executing subject of the second print control processing is the application 105. Only the differences from the first print control processing will be described below. It should be noted that the second print control processing is executed when the user has issued the print instruction of the document data in the step S1207.

As shown in FIG. 14, upon accepting the print instruction from the user (a step S1401), the application 105 causes the output unit 206 to display the print setting screen (a step S1402) (for example, see the step S1208). Here, although the application 105 and the operating system are running within an information processing apparatus, this print setting screen is not a print setting screen provided in the operating system of the client terminal 102, but a print setting screen provided in the application 105. On this print setting screen as well, the user is able to perform the print settings such as the number of copies to print, color, monochrome, etc. In addition, the user is able to select the cloud print service or the printer connected to the local network as the print destination. The user is able to issue a print job transmission instruction by using the selected settings. Next, when the application 105 accepts the print job transmission instruction from the user (a step S1403), the application 105 determines whether or not the setting of the print destination on the print setting screen is the cloud print service 107 (a step S1404).

In the case of being determined in the step S1404 that the setting of the print destination on the print setting screen is not the cloud print service 107, similar to the step S1105, the application 105 causes the print destination to execute the print processing by using a designated printing method (a step S1405). After that, this processing ends.

In the case of being determined in the step S1404 that the setting of the print destination on the print setting screen is the cloud print service 107, similar to the step S1106, the application 105 determines whether or not the image forming apparatus 101 has the capability to process the reference print job (a step S1406) (for example, see the step S1210).

In the case of being determined in the step S1406 that the image forming apparatus 101 has the capability to process the reference print job, similar to the step S1107, the application 105 transmits the reference print job to the cloud print service 107 (a step S1407) (for example, see the step S1211). Based on this print job, the processes of the steps S1212 to S1222 described above are performed. Next, the application 105 receives a print job completion notification from the cloud print service 107 (a step S1408), and ends this processing.

In the case of being determined in the step S1406 that the image forming apparatus 101 does not have the capability to process the reference print job, the application 105 obtains document data from the cloud storage service 108 (a step S1409) (for example, see the steps S1301 and S1302). Next, the application 105 transmits a print job including the obtained document data to the cloud print service 107 (a step S1410) (for example, see the step S1303). Based on this print job, the processes of the steps S1212 to S1215 and S1219 to S1222 described above are performed. After that, the processing proceeds to the step S1408, and this processing ends.

The second cloud print processing shown in FIGS. 12 and 13 and the second print control processing shown in FIG. 14 can also provide the same effects as the first cloud print processing shown in FIGS. 8 and 10 and the first print control processing shown in FIG. 11 that have been described above. It should be noted that the process of the step S1410 can be modified as follows (a modification of the second embodiment). The application 105 transmits the obtained document data (actual data) and the print start request to the print framework of the client terminal 102. The print framework of the client terminal 102 uses the printer driver to generate a print job based on the document data, and transmits the generated print job to the cloud print service 107. In other words, only in the case that the other party supports the reference print job (that is, the other party has the capability to process the reference print job), the printing system 100 is configured such that the application 105 handles the generation, transmission, etc. of the reference print job. On the other hand, in the case that the other party does not support the reference print job, a print processing is requested to the print framework of the client terminal 102 described in the first embodiment.

It should be noted that in the first print control processing and the second print control processing that have been described above, although the configuration has been described in which the reference print job is transmitted in the case of being determined that the image forming apparatus 101 has the capability to process the reference print job, the present invention is not limited to this configuration. For example, in addition to this determination result, based on a determination result of whether or not the image forming apparatus 101 supports the data format of the document data, it may be determined which of the reference print job and the print job including the document data is to be transmitted.

For example, in the case of printing document data in an office document format such as WORD format or Excel format stored in the cloud storage service 108, when the reference print job is used, the image forming apparatus 101 obtains the document data in the office document format as is from the cloud storage service 108. Here, in the case that the image forming apparatus 101 does not support the document data in the office document format, the image forming apparatus 101 is not able to perform printing of the document data obtained from the cloud storage service 108. On the other hand, when the application 105 or the client terminal 102 generate a print job to be transmitted to the image forming apparatus 101 via the cloud print service 107, the application 105 or the client terminal 102 executes a conversion processing to convert the document data in the office document format into a format suitable for printing of PDF or the like, and includes the document data obtained by the conversion processing in the print job. Therefore, the image forming apparatus 101 is able to appropriately execute printing, based on the obtained print job. In view of these, in the second embodiment, in addition to the determination result of whether or not the image forming apparatus 101 has the capability to process the reference print job, based on the determination result of whether or not the image forming apparatus 101 supports the data format of the document data, it is determined which of the reference print job and the print job including the document data is to be transmitted.

For example, in the case that the image forming apparatus 101 has the capability to process the reference print job and the image forming apparatus 101 does not support the data format of the document data, the application 105 or the client terminal 102 transmits, to the cloud print service 107, a print job that includes document data obtained by converting document data to be printed into a format suitable for printing. On the other hand, in the case that the image forming apparatus 101 has the capability to process the reference print job and the image forming apparatus 101 supports the data format of the document data, the application 105 or the client terminal 102 transmits the reference print job to the cloud print service 107. By controlling in this manner, it is possible to avoid a situation where printing cannot be executed due to that the image forming apparatus 101 does not support the data format of the document data.

Furthermore, the cloud print service 107 can be provided with a format conversion function, and the process can be modified as follows (another modification of the second embodiment). In the case that the cloud print service 107 is instructed to print data in a format that allows format conversion, the application 105 or the client terminal 102 transmits the reference print job to the cloud print service 107 regardless of whether or not the image forming apparatus 101 has the capability to process the reference print job. The cloud print service 107 that has received the reference print job specifies the format of the data to be printed based on the URI included in the reference print job. Subsequently, the cloud print service 107 determines whether or not the image forming apparatus 101 supports the reference print job (that is, the image forming apparatus 101 has the capability to process the reference print job) and whether or not the image forming apparatus 101 supports printing of data in the format. In the case that the cloud print service 107 determines that the image forming apparatus 101 supports the reference print job and the image forming apparatus 101 supports printing of data in the format, the cloud print service 107 transfers the reference print job to the image forming apparatus 101. On the other hand, in the case that the cloud print service 107 determines that the image forming apparatus 101 does not support the reference print job, or supports the reference print job but does not support printing of data in the format, the cloud print service 107 performs the conversion processing. Specifically, the cloud print service 107 converts the document data to be printed into a format supported by the image forming apparatus 101 and transmits a print job including the document data obtained by the conversion to the image forming apparatus 101.

Furthermore, in the second print control processing described above, the configuration in which the client terminal 102 is provided with the application 105 is used, but the present invention is not limited to this configuration. The application 105 may be a web application running on an Internet browser. In this case, for example, the cloud integration service 106 provides the Internet browser with screen data of the web application such as Office or a chat application, and JavaScript (registered trademark) for controlling the web application. The Internet browser displays an operation screen of the Web application based on the provided screen data and the provided JavaScript. Thereafter, the back-end server of the cloud integration service 106 and the Internet browser cooperate to perform the print control processing. Specifically, the back-end server performs a search processing, a generation processing of a screen to be displayed, and a determination processing, and the Internet browser performs a screen display processing and an accepting processing of user operations. In this case, in the case that the image forming apparatus 101 has the capability to process the reference print job, the web application transmits the reference print job to the cloud print service 107, and in the case that the image forming apparatus 101 does not have the capability to process the reference print job, the web application transmits the print job including the document data to the cloud print service 107. It should be noted that the print job including the document data may be transmitted via the print framework of the client terminal 102, as described in the modification of the second embodiment.

Furthermore, in the first print control processing and the second print control processing that have been described above, in addition to the determination result that the image forming apparatus 101 has the capability to process the reference print job, based on a determination result of whether or not a capacity of the document data is less than a predetermined capacity, it may be determined which of the reference print job and the print job including the document data is to be transmitted. For example, in the case that the capacity of the document data is greater than or equal to a remaining capacity of the storage of the cloud print service 107 (that is, is greater than or equal to the predetermined capacity), the cloud print service 107 is not able to receive the print job including this document data due to exceeding capacity. Therefore, in the case that the image forming apparatus 101 has the capability to process the reference print job and the capacity of the document data is greater than or equal to the remaining capacity of the storage of the cloud print service 107 (that is, is greater than or equal to the predetermined capacity), the reference print job is transmitted to the cloud print service 107. On the other hand, in the case that the capacity of the document data is less than the remaining capacity of the cloud print service 107, the transmission of the print job including this document data will not be hindered by exceeding capacity. Therefore, in the case that the image forming apparatus 101 has the capability to process the reference print job and the capacity of the document data is less than the remaining capacity of the storage of the cloud print service 107, the print job including the document data is transmitted to the cloud print service 107. By controlling in this manner, it is possible to avoid a situation where printing cannot be executed due to the remaining capacity of the storage of the cloud print service 107.

It should be noted that, in the embodiment described above, although the configuration in which the cloud print service 107 and the cloud storage service 108 are included in the cloud integration service 106 has been described, the present invention is not limited to this configuration. For example, the cloud print service 107 and the cloud storage service 108 may be independently provided, respectively.

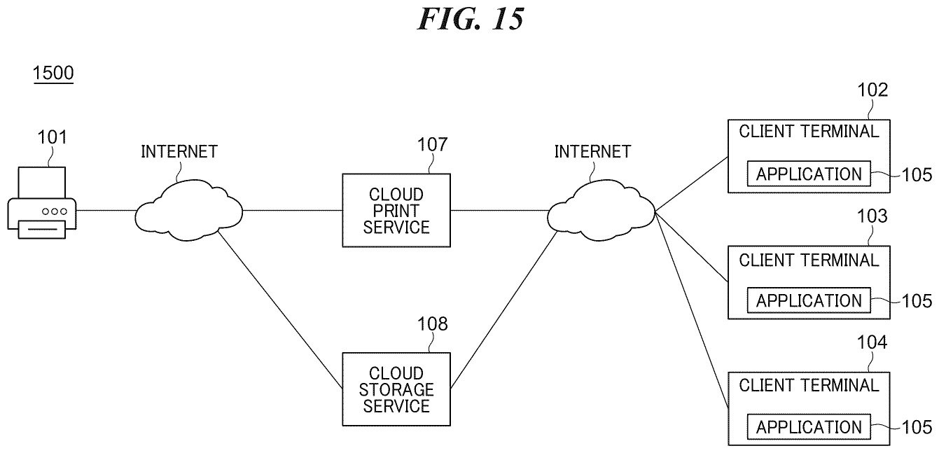

A third embodiment will be described. FIG. 15 is a configuration diagram that shows an example of a printing system 1500 according to the third embodiment. The printing system 1500 is different from the above-described printing system 100, and has a configuration in which the cloud print service 107 and the cloud storage service 108 are independently provided, respectively. The other components are basically the same as those in FIG. 1. The image forming apparatus 101, the cloud print service 107, the cloud storage service 108, and the client terminals 102 to 104 are each communicably connected to each other via the Internet. In the printing system 1500, different authentication information is used when accessing the cloud print service 107 and the cloud storage service 108.

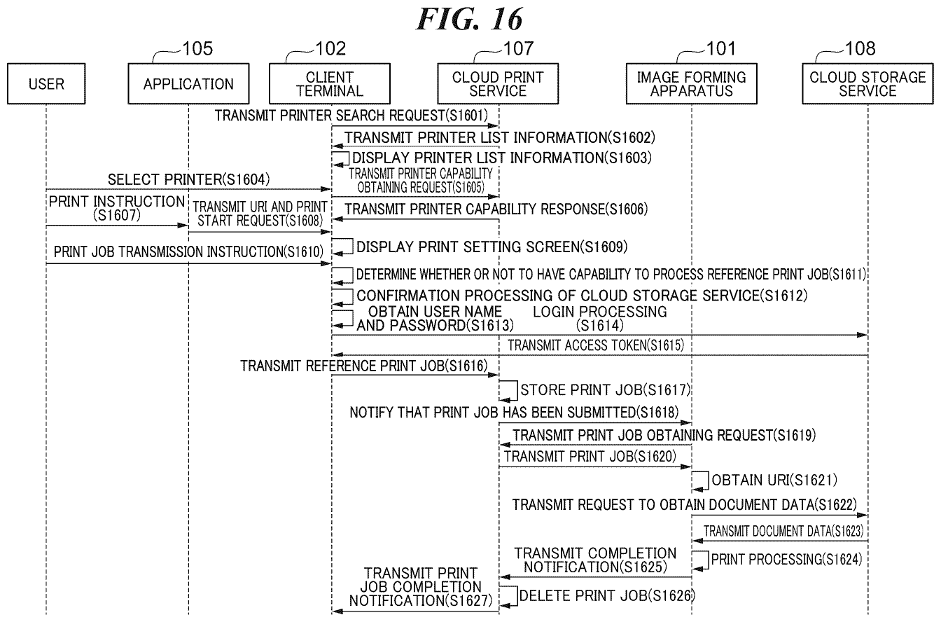

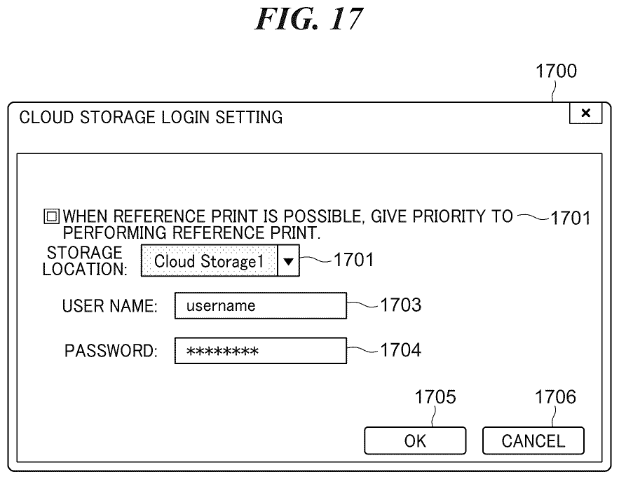

FIG. 16 is a sequence diagram that shows the procedure of a third cloud print processing executed by the printing system 1500 shown in FIG. 15. The third cloud print processing is similar to the first cloud print processing described above, and only the differences from the first cloud print processing will be described below. In the third cloud print processing as well, similar to the first cloud print processing, it is assumed that the printer registration processing of FIG. 4 described above has been executed and the image forming apparatus 101 has already been registered in the cloud print service 107. The third cloud print processing is executed when the user inputs a printer search instruction into the input unit 205 of the client terminal 102. It should be noted that in the third cloud print processing, it is assumed that the settings on a setting screen 1700 shown in FIG. 17 have been made in advance.

FIG. 17 is a diagram that shows an example of the setting screen 1700 displayed on the output unit 206 of the client terminal 102 shown in FIG. 15. The setting screen 1700 includes a check box 1701, a combo box 1702, a user name setting field 1703, a password setting field 1704, an OK button 1705, and a cancel button 1706. The check box 1701 is a check box for setting whether or not to, when it is possible to execute reference print that uses the reference print job, perform the reference print with priority. The combo box 1702 is a combo box for selecting one cloud storage from among a plurality of cloud storages managed by the cloud storage service 108. A user name used when connecting to the cloud storage selected by the combo box 1702 is inputted into the user name setting field 1703. A password used when connecting to the cloud storage selected by the combo box 1702 is inputted into the password setting field 1704. When the OK button 1705 is selected, the setting values set on the setting screen 1700 are stored in the HDD 204 of the client terminal 102, and the setting screen 1700 is closed. When the cancel button 1706 is selected, the setting screen 1700 is closed without storing the setting values set on the setting screen 1700 in the HDD 204 of the client terminal 102.

As shown in FIG. 16, first, processes of steps S1601 to S1611, which are the same processes as the steps S801 to S811 described above, are performed. In the case of being determined in the step S1611 that the image forming apparatus 101 has the capability to process the reference print job, in a step S1612, the client terminal 102 performs a confirmation processing of the cloud storage service to which the client terminal 102 is connected. In this confirmation processing, the client terminal 102 confirms whether or not information in a base part of a URI transmitted from the application 105 in the step S1608 corresponds to the setting value of the combo box 1702 obtained from the HDD 204. For example, in the case that the URI transmitted from the application 105 is “https://example.com/my.cloudstorage/personal/username/Documents/Printdocum ent1.pdf”, the information in the base part of the URI transmitted from the application 105 is “https://example.com/my.cloudstorage”. Here, the client terminal 102 holds in advance information in a base part of a URI corresponding to the cloud storage indicated by the setting value of the combo box 1702 stored in the HDD 204. The client terminal 102 determines whether or not the information in the base part of the URI transmitted from the application 105 in the step S1608 matches the information in the base part of the URI held in advance. As a result of the determination, in the case that the information in the base part of the URI transmitted from the application 105 in the step S1608 matches the information in the base part of the URI held in advance, the processing proceeds to a step S1613.

In the step S1613, the client terminal 102 obtains a user name and a password that are used when connecting to the cloud storage service 108 from the HDD 204. Next, in a step S1614, the client terminal 102 performs a login processing with respect to the cloud storage service 108 by using the obtained user name and the obtained password. It should be noted that, in the present embodiment, although the configuration, in which the login processing is performed by using the user name and the password that have been obtained in the step S1613, has been adopted, the present invention is not limited to this configuration. For example, in the step S1613, the client terminal 102 may display, on the output unit 206, a dialog that prompts the user to input a username and a password, and perform the login processing by using the inputted user name and the inputted password. Next, in a step S1615, the cloud storage service 108 transmits an access token to the client terminal 102. Next, steps S1616 to S1627, which are the same processes as the steps S812 to S823 described above, are performed.

In the third embodiment described above, the cloud storage service 108 and the cloud print service 107 are accessed by using different authentication information. As a result, in the configuration in which the cloud storage service 108 and the cloud print service 107 are independently provided, respectively, it is possible to avoid the situation where printing cannot be executed due to the capacity limit of the cloud print service 107.

It should be noted that, in the third embodiment described above, only in the case that there is no such service that preferentially uses the cloud storage service that can be accessed with the same authentication information as the cloud print service like the printing system 100 shown in FIG. 1, a configuration that uses any cloud storage service may be adopted.

In addition, in the embodiment described above, in the case that the application 105 is holding a user name and a password that are the authentication information of the cloud storage service 108, the application 105 may transmit a print start request including this user name and this password (the authentication information) to the client terminal 102 in the step S1608, and the client terminal 102 may use this authentication information to obtain an access token in the step S1615.

Furthermore, in the embodiment described above, in the case that the application 105 is holding an access token of the cloud storage service 108, the application 105 may transmit a print start request including this access token to the client terminal 102 in the step S1608, and the client terminal 102 may perform the transmission of the print job based on the access token obtained from the application 105 without performing the processes of the steps S1614 and S1615.

In the embodiment described above, options including “normal print” and “reference print” may be displayed on the print setting screen displayed on the output unit 206 of the client terminal 102, and based on the option selected by the user, it may be determined which of the reference print job and the print job including the document data is to be transmitted. For example, in the case that the user has selected the option of “reference print”, the client terminal 102 or the application 105 transmits, to the image forming apparatus 101, the reference print job that has designated the storage location of the document data designated by the user in the URI format without obtaining the document data designated by the user from the cloud storage service 108. On the other hand, in the case that the user has selected the option of “normal print”, the client terminal 102 or the application 105 obtains the document data designated by the user from the cloud storage service 108, and transmits a print job including the obtained document data to the image forming apparatus 101. It should be noted that the user selects “normal print” for example, in the case that the user wants to store the contents of the print job in the client terminal 102 and confirm it, or in the case that the image forming apparatus 101 is not able to access the cloud storage service 108 due to security restrictions or the like.

Furthermore, in the embodiment described above, an on/off button for a download print function that downloads document data and then performs printing of a print job may be displayed on the print setting screen displayed on the output unit 206 of the client terminal 102. In this case, based on the operation of the on/off button performed by the user, it is determined which of the reference print job and the print job including the document data is to be transmitted to the image forming apparatus 101. For example, it is assumed that the download print function is set to turning-off as a default setting. In the case that turning-off of the download print function remaining the default setting has been selected, the client terminal 102 or the application 105 transmits, to the image forming apparatus 101, the reference print job that has designated the storage location of the document data designated by the user in the URI format without obtaining the document data designated by the user from the cloud storage service 108. On the other hand, in the case that the user has selected turning-on of the download print function, the client terminal 102 or the application 105 obtains the document data designated by the user from the cloud storage service 108, and transmits a print job including the obtained document data to the image forming apparatus 101. By controlling in this manner, the user's intention can be easily reflected in that which of the reference print job and the print job including the document data is used.

It should be noted that, in the embodiment described above, although the configuration in which the document data is stored in the cloud storage service 108 has been described, the present invention is not limited to this configuration. For example, the document data may be stored in the storage of the client terminal 102 such as the HDD 204, or the document data may be stored in the storages of the client terminals 103 and 104 other than the client terminal 102. In this way, in the case that the document data that is the target of the print instruction is the local data stored in the local storage of the client terminal 102, regardless of whether or not the image forming apparatus 101 has the capability to process the reference print job, a print start request of the document data that is the target of the print instruction is transmitted to the above-described print framework. According to the present invention, it is possible to suppress the data transfer cost in printing using the cloud print service.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

1. An information processing apparatus that transmits a print job for printing data to an image forming apparatus via a cloud print service, comprising:
at least one processor; and
a memory coupled to the processor storing instructions that, when executed by the processor, cause the processor to function as:
a transmitting unit that transmits the print job to the cloud print service,
wherein in a case that the image forming apparatus has a capability to process a reference print job that has designated a storage location of the data in a predetermined format, in the transmission, the transmitting unit transmits the reference print job to the cloud print service instead of the print job.

2. The information processing apparatus according to claim 1, wherein
in a case that the image forming apparatus has the capability to process the reference print job and the image forming apparatus does not support a data format of the data, the transmitting unit performs a processing of transmitting a print job including data obtained by subjecting the data to a predetermined conversion processing to the cloud print service, instead of a processing of transmitting the reference print job to the cloud print service.

3. The information processing apparatus according to claim 1, wherein
the reference print job includes a token required to access the storage location of the data.

4. The information processing apparatus according to claim 1, wherein
in a case that the image forming apparatus has the capability to process the reference print job and a capacity of the data is greater than or equal to a predetermined capacity, the transmitting unit transmits the reference print job to the cloud print service.

5. The information processing apparatus according to claim 1, wherein
the instructions, when executed by the processor, cause the processor to further function as an obtaining unit that obtains data designated by a user from a cloud storage that stores a plurality of pieces of data, and
in a case that the image forming apparatus does not have the capability to process the reference print job that has designated the storage location of the data in the predetermined format, the transmitting unit transmits, to the cloud print service, a print job generated based on data obtained from the storage location of the data by using the obtaining unit.

6. The information processing apparatus according to claim 5, wherein
the cloud storage and the cloud print service are accessed by using the same authentication information.

7. The information processing apparatus according to claim 5, wherein
the cloud storage and the cloud print service are accessed by using different authentication information.

8. The information processing apparatus according to claim 1, wherein
an application and an operating system run on the information processing apparatus,
in a case that the image forming apparatus does not have the capability to process the reference print job, the transmitting unit provided by the application transmits a print start request of the data to a print framework of the operating system, and
the print framework that has received the print start request performs a processing of transmitting a print job including data obtained by subjecting the data to a predetermined conversion processing to the cloud print service.

9. The information processing apparatus according to claim 8, wherein
in a case that data to be printed is data that has been stored in the cloud print service and the image forming apparatus has the capability to process the reference print job, the transmitting unit provided by the application transmits the reference print job, and
in a case that the data to be printed is local data that has been stored in a local storage of the information processing apparatus, the transmitting unit provided by the application transmits a print start request of the local data to the print framework, regardless of whether or not the image forming apparatus has the capability to process the reference print job.

10. A control method for an information processing apparatus that transmits a print job for printing data to an image forming apparatus via a cloud print service, the control method comprising:
transmitting the print job to the cloud print service,
wherein in a case that the image forming apparatus has a capability to process a reference print job that has designated a storage location of the data in a predetermined format, in the transmission, the reference print job is transmitted to the cloud print service instead of the print job.

11. A non-transitory computer-readable storage medium storing a program for causing a computer to execute a control method for an information processing apparatus that transmits a print job for printing data to an image forming apparatus via a cloud print service,
the control method comprising:
transmitting the print job to the cloud print service,
wherein in a case that the image forming apparatus has a capability to process a reference print job that has designated a storage location of the data in a predetermined format, in the transmission, the reference print job is transmitted to the cloud print service instead of the print job.
